(19) United States
(12) Patent Application Publication
(10) Pub. No.: US 2026/0259729 A1
(43) Pub. Date: Sep. 3, 2026

(54) COMPUTER CODE MODIFICATION USING LANGUAGE MODEL NEURAL NETWORKS

(71) Applicant: Google LLC, Mountain View, CA (US)

(72) Inventors: Daniel Stefan Tarlow, Montreal (CA); Petros Maniatis, Mountain View, CA (US); Alexander Werner Frömmgen, Östringen (DE); Valeriya Kharatyan, Munich (DE); Peter Choy, London (GB); Jacob Austin, New York City, NY (US); Gabriela De Castro Surita, London (GB); Kevin Alexander Villela, Walkerton, IN (US); Daniel Fangda Zheng, Mountain View, CA (US); Pierre-Antoine Manzagol, Montreal (CA); Pascal Lamblin, Montréal (CA); Krzysztof Jacek Gorgolewski, New York, NY (US); Manushree Vijayvergiya, Thalwil (CH); Vaibhav Sunil Tulsyan, Sunnyvale, CA (US); Jessica Chia-Wen Ko, Mountain View, CA (US); Emily Patricia Marie Johnston, Sunnyvale, CA (US); Franjo Ivancic, Princeton, NJ (US); Malgorzata Krystyna Salawa, Zurich (CH)

(21) Appl. No.: 19/489,188

(22) PCT Filed: May 31, 2024
(86) PCT No.: PCT/US2024/032083

§ 371 Date: Dec. 1, 2025

(30) Foreign Application Priority Data
May 31, 2023 (GR) 20230100434

(51) Int. Cl. G06F 8/73; G06N 3/0455

(52) U.S. Cl. CPC G06F 8/73; G06N 3/0455

(57) ABSTRACT

Systems and methods for performing software development tasks using a language model neural network. The software development tasks can include any of a variety of tasks that require modifying computer program code in one or more programming languages. For example, the language model neural network can be used to predict code edits that will be made to a piece of computer code, to predict comments that will be left on a piece of computer code by a code reviewer, to resolve comments on a piece of computer code, to predict edits that will repair a given code build, or to predict build errors that will result from compiling a piece of computer code. To perform these tasks, the system represents code development actions as tokens in a domain-specific language and processes these tokens using the language model neural network.

### CROSS-REFERENCE TO RELATED APPLICATIONS

This application claims the benefit of priority to Greece Patent Application Serial No. 20230100434, filed on May 31, 2023, the contents of which are hereby incorporated by reference.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that performs software development tasks using a language model neural network.

Particular embodiments of the subject matter described in this specification can be implemented so as to realize one or more of the following advantages.

Large language models (LLMs) have shown the ability to generate computer code conditioned on natural language, surrounding code, or both. However, these existing models are trained with a static view of code and in isolation from the context in which code is developed. That is, existing approaches make predictions for a single, static snapshot of code.

The described techniques, on the other hand, describe how a language model can be used to perform a software development task: to predict the behavior of human software developers editing, debugging, and reviewing code in context. In other words, the described techniques leverage a language model neural network and a domain-specific language in order to accurately predict outputs of any of a variety of software development tasks.

By predicting outputs for the software development task, the system can improve any of a variety of aspects of the software development pipeline. For example, the system can be used to predict any of the temporal evolution of code (e.g., code edits), interactions with tools (e.g., the compiler), and collaboration with other developers (e.g., in code review) in order to significantly speed up the software development process and to improve the quality of the code that is generated as a result of the process.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example user interface.

FIG. 3 shows an example of software development tasks that can be performed by the system.

FIG. 4 is a flow diagram of an example process for performing a software development task.

FIG. 5 is a flow diagram of an example process for generating an output at a given position in the output sequence.

Like reference numbers and designations in the various drawings indicate like elements.

### DETAILED DESCRIPTION

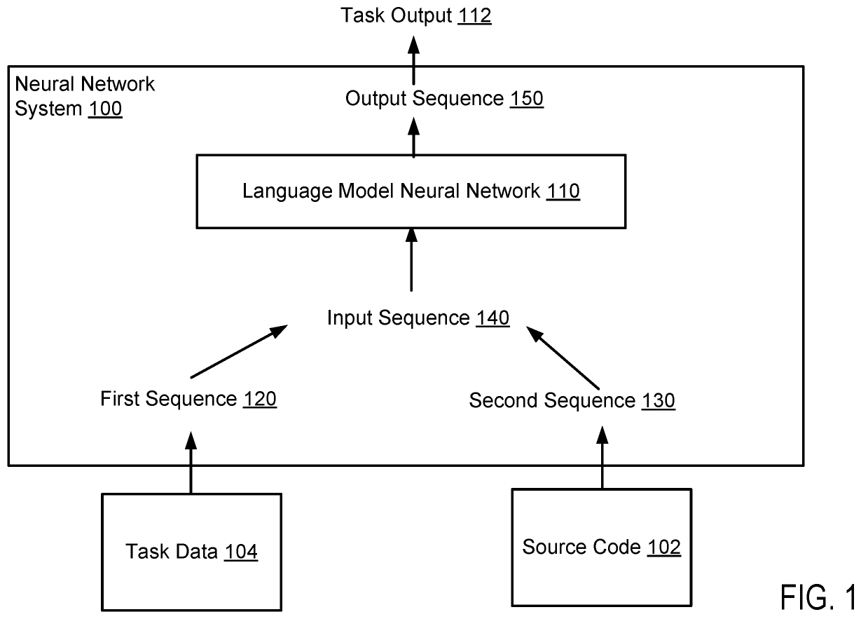

FIG. 1 shows an example neural network system 100. The neural network system 100 is an example of a system implemented as computer programs on one or more computers in one or more locations, in which the systems, components, and techniques described below can be implemented.

The system 100 performs software development tasks using a language model neural network 110.

The software development tasks can include any of a variety of tasks that require modifying computer program code in one or more programming languages.

For example, modifying computer program code can refer to editing source code, generating annotations for the source code, or both.

Editing source code can refer to, e.g., deleting existing source code at a particular location in a source code file, adding new source code at a particular location in a source code file, or both.

An “annotation” can refer to, e.g., a comment on a particular portion of code, an indication of an error in a particular portion of code, e.g., an error that will cause a build error when the code is compiled, and so on.

A “location” in a source code file can refer, e.g., to a particular line of source code within a source code file, or to a particular set of one or more tokens within the particular line of source code.

For example, the language model neural network 110 can be used to predict code edits that will be made to a piece of computer code, e.g., to a source code file, to multiple source code files, or to a portion of a source code file. That is, the task can be a source code editing task that receives input source code and generates as output a prediction of one or more edits to the source code.

That is, the software development task can require predicting edits that would be made to a piece of code by a code reviewer as part of a software development process.

In some cases, the code editing task can be a general code editing task that does not constrain the types of edits that can be made.

In some other cases, the code editing task can require predicting a specific type of edit.

As a particular example of such a task, the task can be a variable renaming task that requires identifying one of the variables in the input source code and predicting a new name for the variable, e.g., to improve readability of the source code, to improve consistency in variable names across the input source code, and so on.

As another particular example of such a task, the task can be a code completion task, where the input is input source code and a reference location in the source code and the output is to predict a code edit at the reference location, e.g., source code that would be added at the location. In some of these examples, the input also identifies one or more most-recent code edits that have been made to the input source, i.e., so that the language model is given additional historical context when proposing the code edit.

As another example, the language model neural network 110 can be used to predict comments that will be left on a piece of computer code by a code reviewer. That is, the software development task can be a code commenting task that receives input source code and predicts one or more comments that would be made on the input source code in one or more locations within the input source code by a code reviewer.

As another example, the language model neural network 110 can be used to resolve comments on a piece of computer code. That is, the software development task can require resolving comments that were made on a piece of code, e.g., by a code reviewer or by performing the comment prediction task using the language model neural network. “Resolving comments” can refer to editing the source code to address an issue raised by the comment. In other words, the software development task can be a code resolving task that receives input source code and one or more comments on the source code and predicts as output one or more edits that would be required to resolve the one or more comments.

As another example, the language model neural network 110 can be used to predict edits that will repair a given code build. In other words, the software development task can be a code repair task that receives input source code and annotations that identify one or more errors, e.g., build errors triggered by a compiler or predicted using the language model neural network, within the source code and predicts as output one or more edits that would be required to resolve the one or more errors.

As another example, the language model neural network 110 can be used to predict errors that will result from compiling a piece of computer code. In other words, the software development task can be an error prediction task that receives input source code and predicts as output one or more errors, e.g., build errors that would be triggered by a compiler if the source code were complied, within the source code.

In either of the above examples, the errors can be any of a variety of types of errors that can be identified in source code. For example, the error can be a build error as described above, a static analysis error generated by a static analysis engine by processing the source code, a dynamic analysis error generated by a dynamic analysis engine by processing the source code, and so on.

As another example, the code can be code that will be executed on specialized processors, in heterogenous processing environments, or both. As a particular example, specialized processors can include ASICs, e.g., graphics processing units (GPUs), tensor processing units (TPUs), and so on. The heterogenous processing environments can include a mixture of CPUs and ASICs. In this example, the task can be to predict errors that will result in code that can be more efficiently executed on the specialized processors or within the heterogenous processing environment. As a particular example of this, the task can be to predict optimizations that will be made to the code by a specialized compiler, i.e., to predict code edits that result in the code being more efficiently compiled for execution on the specialized processors or within the heterogenous processing environment.

Many other software development tasks that require processing computer code are possible. For example, software development tasks can include code maintenance tasks, e.g., fixing or maintaining code based on reported bugs, upgrading code to a new library versions, and so on.

To perform these tasks, the system 100 represents code development actions as tokens in a domain-specific language and processes these tokens using the language model neural network 110.

More specifically, the system receives input source code 102 in a programming language.

The system 100 also receives data 104 specifying a software development task to be performed on the input source code 102.

In some cases, the system 100 is a multi-task system that can perform any of a variety of software development tasks. That is, by virtue of conditioning the language model neural network 110 on data specifying a given task, the output generated by language model neural network 110 will be an output for the given task. By conditioning the neural network 110 differently, the neural network 110 can be caused to generate an output for a different task.

To perform a given instance of a task, the system 100 generates a first sequence 120 of text tokens from a vocabulary of text tokens that describes the software development task. For example, the first sequence 120 can be a natural language description of the task represented as tokens from vocabulary.

The system 100 also generates a second sequence 130 of text tokens from the vocabulary of text tokens that represents at least the input source code 102.

When the task requires operating on one or more annotations in addition to the input source code, the second sequence 130 also represents the one or more input annotations.

The system 100 processes an input sequence 140 that includes both the first sequence 120 of text tokens and the second sequence 130 of text tokens using the language model neural network 110 to generate, as output, an output sequence 150 of text tokens in the domain specific language.

The system 100 then generates, from the output sequence 150 in the domain specific language, an output 112 for the software development task.

For example, the system 100 can resolve the output sequence 150 in the domain specific language into edits or annotations that can be displayed at the appropriate locations within the input source code 102.

The system 100 can then, e.g., provide the output for presentation to the user, e.g., as suggested edits or annotations on the input source code, or automatically apply the output to the input source code in order to perform the software development task.

That is, in some implementations, the system 100 provides the task output for presentation to a user, e.g., in a user interface of a source code editing software tool or a source reviewing software tool, as a suggested code edit or a suggested annotation that the user can review before determining whether to apply to the input source code.

In some other implementations, the system 100 automatically applies the task output to the input source code to modify the input source code accordingly.

In some implementations, the system 100 can perform multiple software development tasks on the input source code 102 in sequence, i.e., one after the other. That is, each task after the first task in the sequence receives as input the source code after being modified by the task output for the previous task.

As one example, the system 100 can first perform the code commenting task to predict one or more comments on input source code 102 and then perform the comment resolving task to resolve the predicted comments.

As another example, the system 100 can first perform the error prediction task to predict one or more errors in input source code and then perform the error resolving task to resolve the predicted errors.

In some implementations, after performing one or more tasks on input source code to generate modified source code, the system 100 can then cause the modified source code to be executed on one or more hardware devices, e.g., by compiling the code into machine code and causing the one or more hardware devices to execute the machine code.

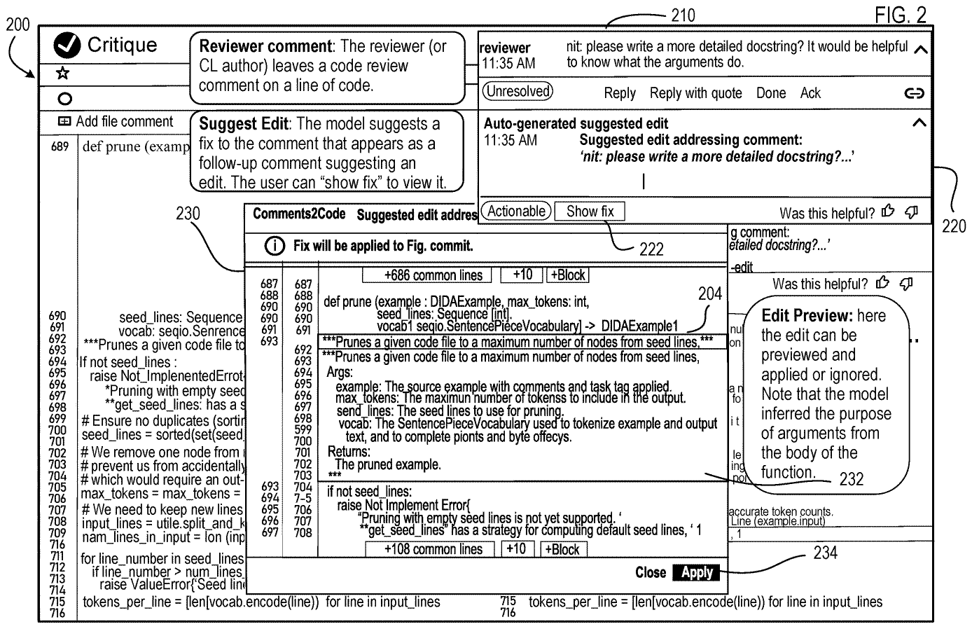

FIG. 2 shows an example user interface 200 that shows an example of displaying the output of the task that requires the system 100 to resolve a comment that was made on a piece of code.

In particular, in the example of FIG. 2, a reviewer has left a comment 210 on a line of code 204 that suggests including a more detailed docstring.

As will be described below, the system 100 has processed the code, i.e., the line of code 204 and other code surrounding the line of code 204 within the source code file, and the comment 210 to perform the task, i.e., to resolve the comment, and has generated, as output, a suggested edit to the code.

As a result, the user interface 200 displays an indication 220 that an auto-generated suggested edit 232 to the code is available that addresses the comment.

The indication 220 includes a user interface element 222 that, if selected by the user, displays a suggested edit window 230. The window 230 shows the code with the suggested edit 232 displayed, i.e., the more detailed docstring that would replace the original docstring in the code.

The suggested edit window 230 includes a user interface element 240 that, if selected by the user, results in the underlying code being modified to incorporate the suggested edit 232.

Thus, through the user interface 200, a user can review and determine whether to adopt the outputs generated by the system 100 in order to significantly accelerate the process of modifying source code in order to address reviewer comments. Similar benefits can be achieved for the other tasks described above and below that can be performed by the system 100.

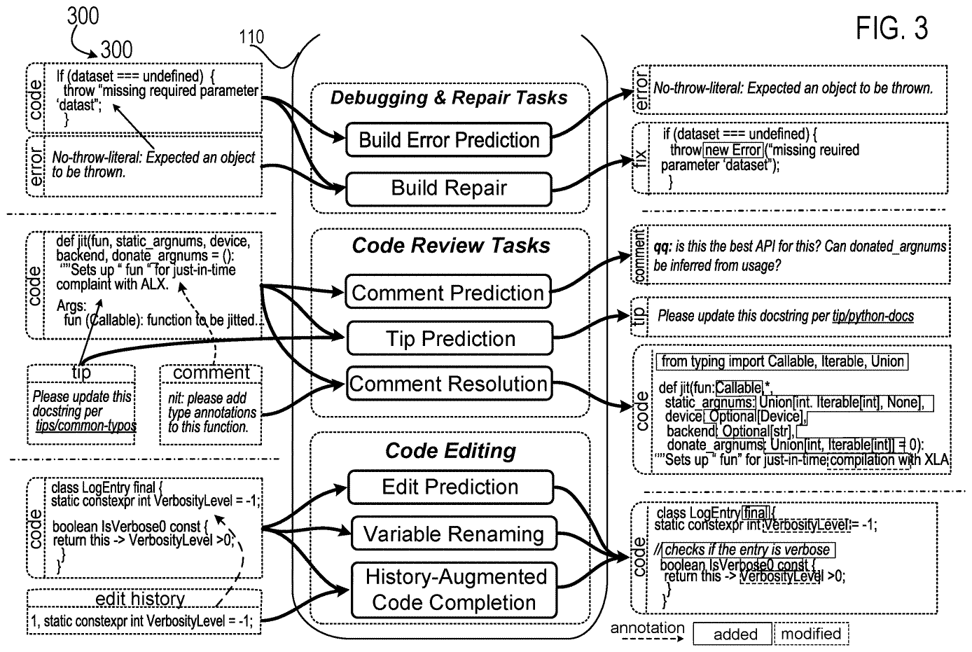

FIG. 3 shows an example set 300 of software development tasks that can be performed by the system 100.

In particular, FIG. 3 shows example inputs and outputs for a set of software development tasks that can be performed by the system 100.

The set of tasks include code debugging and repair tasks (build error prediction, build repair), code review tasks (comment prediction, tip prediction, comment resolution), and code editing tasks (edit prediction, variable renaming, history-augmented code completion).

As can be seen from FIG. 3, for some tasks, the input is only the source code on which the task is to be performed while, for other tasks, the input also includes additional data. One example of additional data is data that can be represented as annotations that are associated with particular portions of the code, e.g., lines of the code or specific code fragments within a line of the code. Examples of annotations include, e.g., errors that have been detected in the code, tips or comments left on the code, or an edit history of the code.

While FIG. 3 shows three types of software development tasks, the system can instead or in addition perform other types of tasks, e.g., code maintenance tasks as described above.

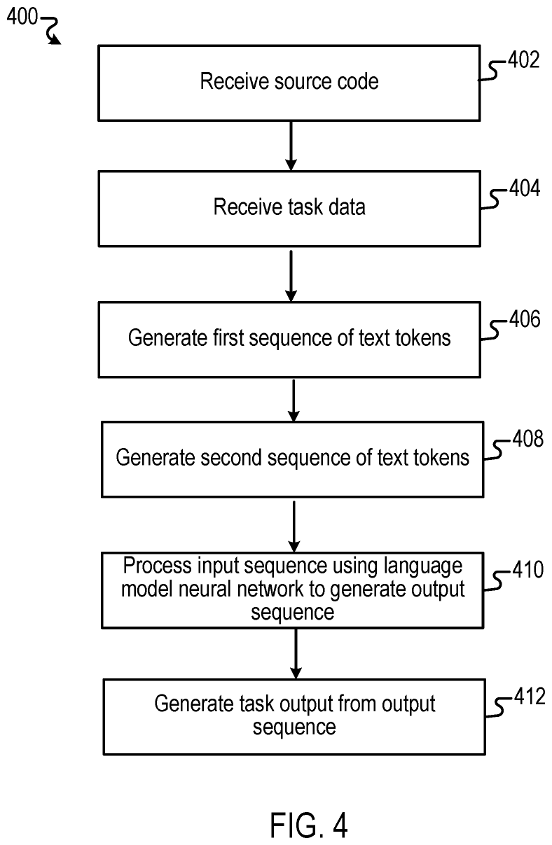

FIG. 4 is a flow diagram of an example process 400 for performing a software development task. For convenience, the process 400 will be described as being performed by a system of one or more computers located in one or more locations. For example, a neural network system, e.g., the neural network system 100 of FIG. 1, appropriately programmed, can perform the process 400.

The system receives input source code in a programming language (step 402). In some cases, e.g., when the task is a cross-language task, the system can also receive input source code in another programming language. That is, the input source code can include a first portion of code in one programming language and another portion of code in another programming language.

The system receives data specifying a software development task to be performed on the input source code (step 404).

In some cases, the system is a multi-task system that performs different tasks for different inputs. In these cases, the system can receive the data specifying the task along with the input source code on which the task is to be performed. In some other cases, the system is a single-task system that performs only a single task, and the system can receive the data specifying the task in advance and use the same data for all source code inputs.

In some cases, the data also specifies one or more annotations for the input source code, e.g., comments on certain locations in the input source code, errors identified at certain locations in the input source code and so on.

The system generates a first sequence of text tokens from a vocabulary of text tokens that describes the software development task (step 406).

For example, the first sequence of text tokens can be a natural language description of the software development task.

For example, the data specifying the software development tasks can be a natural language description and the system can generate the first sequence of text tokens by applying a text tokenizer, e.g., the SentencePiece tokenizer or another appropriate tokenizer, to represent the task data as a sequence of text tokens from the vocabulary. As another example, the task data can be an identifier for the task and the system can map the task data to the first sequence, i.e., to a tokenized natural language description of the task.

The system generates a second sequence of text tokens from the vocabulary of text tokens that represents at least the input source code (step 408).

As described above, in some cases the system also receives one or more annotations for the input source code.

In these cases, the second sequence of text tokens represents the one or more annotations and the input source code.

As a particular example of this, as part of generating the second sequence, the system can insert the one or more annotations at respective positions in-line within the input source code to generate annotated source code. That is, for each annotation, the system can insert the annotation in-line within the source code at the location to which the annotation refers.

The system can generate a sequence of text tokens that represents the annotated source code, e.g., by tokenizing the annotated source code using the tokenizer.

However, the language model neural network will generally have a limited context length, i.e., a maximum number of input tokens that can be included in any given input sequence that is processed by the language model neural network.

To account for this, the system can determine whether the annotated source code exceeds a maximum context length for the language model neural network. That is, the system determines whether the number of tokens that are required to represent the annotated source code exceeds the maximum number of input tokens that can be included in any given input sequence (minus the number of tokens reserved for the first sequence of tokens within the input sequence).

If the system determines whether the annotated source code exceeds the maximum context length for the language model neural network, the system can prune the annotated source code based on the respective positions of the one or more annotations to generate pruned annotated source code that does not exceed the maximum context length.

Generally, when performing the pruning, the system can use the annotations as indicators of which portions of the source code are relevant for performing the task and which portions can be removed without adversely impacting the resulting quality of the output generated by the system.

For example, the system can select one or more lines of the annotated source code to remove based on, for each line in the annotated source code, the distance of the line from the respective positions of the one or more annotations within the annotated source code. As a particular example of this, the system can select an initial context, i.e., an initial set of tokens that are included in the second sequence, as the set of seed lines based on the line locations of any annotations. The system can then perform a breadth-first expansion of this context over adjacent lines, until the size of the context uses the full input token budget, i.e., the maximum number of tokens available for the second sequence within the input sequence.

The system can then tokenize the pruned annotated source code to generate the sequence of text tokens that represents the annotated source code.

When the input source code also included source code in another programming language, the second sequence can also represent the source code in the other programming language (e.g., generated as described above).

After generating the second sequence, the system processes an input sequence that includes the first sequence of text tokens and the second sequence of text tokens using the language model neural network to generate, as output, an output sequence of text tokens in a domain specific language (step 410).

For example, the input sequence can include the first sequence followed by the second sequence. As a particular example of this, the first sequence can be represented as an annotation at a beginning of the input source code. That is, the input sequence can represent the first sequence of tokens as a code annotation that precedes the source code.

Generally, the domain specific language represents the outputs of software development tasks as actions.

In particular, developers perform many actions while writing code: for example, opening and editing files, running builds, and leaving code-review comments. To allow the neural network to reproduce these actions, the system describes trajectories of developer actions as sequences of commands in a domain-specific language (DSL).

Some examples of actions that can be represented in the DSL include code editing actions (INSERT and DELETE) as well as code review actions (ADD COMMENT and ADD COMMENT URL), and diagnostic prediction (DIAGNOSTIC).

More specifically, the domain specific language represents each of a plurality of software development actions as at least (i) a sequence of tokens from the vocabulary that identify the action (from a set of supported actions) and (ii) a pointer to a location in the input source code where the action is to be applied.

Thus, the output sequence includes tokens from the vocabulary and one or more tokens representing one or more pointers to respective locations in the input source code.

For some actions, just (i) and (ii) may be insufficient to represent the action. For example, the INSERT action requires not only the location where to insert new code, but also a sequence that specifies the new code to be inserted. As another example, the ADD COMMENT action requires not only the location where to insert the new comment, but also a sequence that specifies the content of the new comment.

Thus, for one or more of the actions, the domain specific language can represent the action as a sequence of tokens from the vocabulary that identify the action, a pointer to a location in the input source code where the action is to be applied, and another sequence of tokens from the vocabulary. This other sequence of tokens specifies an (i) edit applied to the input source code at the location specified by the pointer or (ii) an annotation that refers to the location specified by the pointer.

Table 1 shows an example of some actions that can be supported by the domain-specific language:

TABLE 1

| DevScript Action | Grammar |
|---|---|
| INSERT | INSERT pointer code |
| DELETE | DELETE pointer* |
| ADD_COMMENT | ADD_COMMENT pointer comment_text |
| ADD_COMMENT_URL | ADD_COMMENT_URL pointer url |
| RENAME | RENAME pointer identifier |
| DIAGNOSTIC | INSERT pointer error_type error_text |
| | error_attribute+ |

In Table 1, the Grammar field refers to the representation of the action in the output sequence and pointer indicates a token that refers to a location in the source code. Thus, for the INSERT action, the action is represented within the output sequence as a sequence of tokens representing the word “INSERT” followed by a token identifying a location within the source code (the “pointer”) and a sequence of tokens representing the code to be inserted at the pointer location (“code”).

Generally, the language model neural network can have any appropriate language model architecture that allows the neural network to map the input sequence to an output sequence of tokens.

For example, the neural network can be a decoder-only Transformer neural network.

As another example, the neural network can have an encoder-decoder architecture.

In this example, the encoder neural network is configured to process the input sequence to generate a respective encoder output for each token in the input sequence and the decoder neural network is configured to generate the output sequence conditioned on the encoder outputs for the tokens in the input sequence.

For example, the encoder neural network can be a Transformer encoder neural network and the decoder neural network can be a Transformer decoder neural network. As another example, one or both of the neural networks can be recurrent neural networks or neural networks that have a mix of recurrent and attention layers.

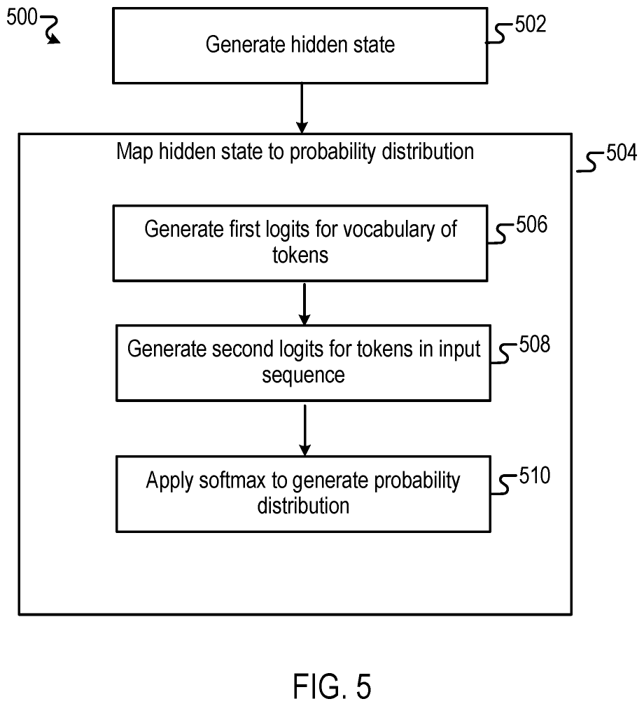

In the above example, the decoder neural network is configured to autoregressively generate the output sequence conditioned on the input sequence by generating the tokens in the output sequence one after the other. This will be described in more detail below with reference to FIG. 5.

The system generates, from the output sequence in the domain specific language, an output for the software development task (step 412). In particular, the system resolves the output sequence into one or more actions to be applied to the input source code. For example, the system can parse the output sequence according to the DSL in order to identify the one or more actions specified in the output sequence and, for each sequence, the location in the input source code where the action should be applied and, for some actions, the content to be inserted at the location or the annotation that refers to the location.

Prior to using the language model neural network to perform the software development task, the system or another training system trains the neural network. Generally, the training system can train the language model neural network on training examples for a plurality of software development tasks. That is, the system trains the neural network on training data that includes a mixture of training examples for different tasks.

Each training example includes (i) a first sequence specifying the corresponding task, (ii) a second sequence representing input code or, optionally, annotated input code as described above and (iii) an output sequence that represents, in the DSL, a set of one or more ground truth actions required to perform the task.

The system can train the neural network on these training examples to optimize an appropriate language modeling objective, e.g., a next token prediction objective.

In some cases, after training the neural network in this manner, the system then proceeds to use the neural network to perform multiple different tasks. In some of these cases, the neural network can be used to generalize to new tasks that were not seen in the training data. For example, the task on which the process 400 is being performed can be a task that was not present in the training data used to train the neural network.

In some other cases, the system then fine-tunes the neural network on task-specific training examples for a particular task, i.e., one of the multiple tasks used for the initial training or a new task, and then, after the training, uses the neural network to perform the new task.

FIG. 5 is a flow diagram of an example process 500 for generating an output at a given position in the output sequence. For convenience, the process 500 will be described as being performed by a system of one or more computers located in one or more locations. For example, a neural network system, e.g., the neural network system 100 of FIG. 1, appropriately programmed, can perform the process 500.

As described above, the language model neural network auto-regressively generates the outputs at the output positions in the output sequence, so that each output depends on the outputs at preceding positions.

To generate the output at a given position using the decoder neural network of the language model neural network, the system can generate a probability distribution over (i) the vocabulary of text tokens and (ii) respective locations within the input source code and then select, using the probability distribution, a text token from the vocabulary or a respective location within the input source code as the token at the position in the output sequence. For example, the system can sample an output from the probability distribution or can greedily select the output having the highest probability. As a particular example, each location can correspond to a respective token in the second sequence.

Generally, to generate the probability distribution at a given time step, the decoder neural network can process the tokens at positions preceding the position in the output sequence conditioned on the encoder outputs to generate a hidden state for the position in the output sequence (step 502). For example, the hidden state can be the output of the last attention block in the decoder neural network for the token at the immediately preceding position.

That is, generally, to process the tokens at positions preceding the position in the output sequence, the decoder maps each token to a respective embedding and then processes the embeddings through a sequence of attention blocks. Some of these attention blocks can be self-attention blocks while, when the neural network has an encoder-decoder architecture, others can be cross-attention blocks.

In some implementations, the system uses a respective learned embedding for each token at the input to the decoder. In some other implementations, when the token is a location within the input source code, the decoder can use the encoder output for the corresponding token in the input sequence as the respective embedding for the location.

The system can then map the hidden state to the probability distribution (step 504).

As a particular example of this, to generate the probability distribution from the hidden state, the system can generate a respective first logit for each token in the vocabulary of text tokens by applying an output embedding matrix to the hidden state (step 506). That is, the system computes a product between the output embedding matrix and the hidden state to generate a vector that includes a respective value (“first logit”) for each token in the vocabulary.

The system can then generate a respective second logit for each of the tokens in the input sequence that corresponds to one of the respective locations by computing a dot product between the hidden state and the encoder output for the token (step 508).

The system then applies a softmax to the first and second logits to generate the probability distribution (step 510).

By performing the process 500 to generate the probability distribution, the system adapts the decoder neural network to also be able to generate tokens representing locations in the input without adding any additional parameters relative to a decoder neural network that can only generate tokens from the vocabulary.

The above description generally describes generating outputs for software development tasks in a domain specific language for software development. More generally, however, the above techniques can be used to perform a variety of types of tasks in a variety of domains that require generating pointers to portions of an input, i.e., by generating outputs for the tasks in a domain specific language adapted for the corresponding domain.

For example, the above techniques can be used to perform editing tasks on text inputs or inputs that are in a markup language.

As another example, the above techniques can be used to perform image editing tasks on input images.

As another example, the above techniques can be used to perform chip design tasks. As one example, the input can be a netlist for a computer chip and the task can be to modify or annotate the netlist.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving input source code in a programming language;
receiving data specifying a software development task to be performed on the input source code;
generating a first sequence of text tokens from a vocabulary of text tokens that describes the software development task;
generating a second sequence of text tokens from the vocabulary of text tokens that represents at least the input source code;
processing an input sequence comprising the first sequence of text tokens and the second sequence of text tokens using a language model neural network to generate, as output, an output sequence of text tokens in a domain specific language; and
generating, from the output sequence in the domain specific language, an output for the software development task.

2. The method of claim 1, wherein the first sequence of text tokens is a natural language description of the software development task.

3. The method of claim 1, wherein:
the data specifying the software development task comprises one or more annotations for the input source code, and
the second sequence of text tokens represents the one or more annotations and the input source code.

4. The method of claim 3, wherein generating a second sequence of text tokens from the vocabulary of text tokens that represents at least the input source code comprises:
inserting the one or more annotations at respective positions in-line within the input source code to generate annotated source code; and
generating a sequence of text tokens that represents the annotated source code.

5. The method of claim 4, wherein generating a sequence of text tokens that represents the annotated source code comprises:
determining that the annotated source code exceeds a maximum context length for the language model neural network; and
in response:
pruning the annotated source code based on the respective positions of the one or more annotations to generate pruned annotated source code that does not exceed the maximum context length; and
tokenizing the pruned annotated source code to generate the sequence of text tokens that represents the annotated source code.

6. The method of claim 5, wherein pruning the annotated source code comprises:
selecting one or more lines of the annotated source code to remove based on, for each line in the annotated source code, a distance of the line from the respective positions of the one or more annotations within the annotated source code.

7. The method of claim 1, wherein the input sequence comprises the first sequence followed by the second sequence.

8. The method of claim 7, wherein the first sequence is represented as an annotation at a beginning of the input source code.

9. The method of claim 1, wherein the software development task requires generating one or more edits to the input source code, one or more annotations on the input source code, or both.

10. The method of claim 1, wherein the domain specific language represents each of a plurality of software development actions as at least a sequence of tokens from the vocabulary that identify the action and a pointer to a location in the input source code where the action is to be applied, and wherein the output sequence comprises tokens from the vocabulary and one or more tokens representing one or more pointers to respective locations in the input source code.

11. The method of claim 10, wherein, for one or more of the actions, the domain specific represents the action as a sequence of tokens from the vocabulary that identify the action, a pointer to a location in the input source code where the action is to be applied, and another sequence of tokens from the vocabulary that specify an (i) edit applied to the input source code at the location specified by the pointer or (ii) an annotation that refers to the location specified by the pointer.

12. The method of claim 1, wherein the language model neural network comprises:
an encoder neural network that is configured to process the input sequence to generate a respective encoder output for each token in the input sequence; and
a decoder neural network that is configured to generate the output sequence conditioned on the encoder outputs for the tokens in the input sequence.

13. The method of claim 12, wherein the encoder neural network is a Transformer encoder neural network and the decoder neural network is a Transformer decoder neural network.

14. The method of claim 12, wherein the domain specific language represents each of a plurality of software development actions as at least a sequence of tokens from the vocabulary that identify the action and a pointer to a location in the input source code where the action is to be applied, and wherein the output sequence comprises tokens from the vocabulary and one or more tokens representing one or more pointers to respective locations in the input source code, wherein the decoder neural network is configured to autoregressively generate the output sequence conditioned on the input sequence, comprising:
for each position in the output sequence:
generating a probability distribution over (i) the vocabulary of text tokens and (ii) respective locations within the input source code conditioned on the encoder outputs and any tokens at positions preceding the position in the output sequence and
selecting, using the probability distribution, a text token from the vocabulary or a respective location within the input source code as the token at the position in the output sequence.

15. The method of claim 14, wherein, the decoder neural network is configured to, for each position in the output sequence:
process the tokens at positions preceding the position in the output sequence conditioned on the encoder outputs to generate a hidden state for the position in the output sequence; and
map the hidden state to the probability distribution.

16. The method of claim 15, wherein each of the respective locations corresponds to one of the tokens in the input sequence, and wherein mapping the hidden state to the probability distribution comprises:
generating a respective first logit for each token in the vocabulary of text tokens by applying an output embedding matrix to the hidden state;
generating a respective second logit for each of the tokens in the input sequence that corresponds to one of the respective locations by computing a dot product between the hidden state and the encoder output for the token; and
applying a softmax to the first and second logits to generate the probability distribution.

17. The method of claim 15, wherein processing the tokens at positions preceding the position in the output sequence comprises:
mapping each token to a respective embedding, wherein, when the token is a location within the input source code, mapping the token to a respective embedding comprises using the encoder output for the corresponding token in the input sequence as the respective embedding.

18. The method of claim 1, wherein the language model neural network has been trained on training examples for a plurality of software development tasks.

19. The method of claim 18, wherein the software development task is one of the plurality of software development tasks.

20. The method of claim 18, wherein the software development task is not one of the plurality of software development tasks.

21. The method of claim 1, further comprising receiving input source code in another programming language, and wherein the second sequence represents at least the input source code in the other programming language and the input source code in the programming language.

22. A system comprising one or more computers and one or more storage devices storing instructions that are operable, when executed by the one or more computers, to cause the one or more computers to perform operations:
receiving input source code in a programming language;
receiving data specifying a software development task to be performed on the input source code;
generating a first sequence of text tokens from a vocabulary of text tokens that describes the software development task;
generating a second sequence of text tokens from the vocabulary of text tokens that represents at least the input source code;
processing an input sequence comprising the first sequence of text tokens and the second sequence of text tokens using a language model neural network to generate, as output, an output sequence of text tokens in a domain specific language; and
generating, from the output sequence in the domain specific language, an output for the software development task.

23. (canceled)
